(19) United States
(12) Patent Application Publication
(10) Pub. No.: US 2007/0241872 A1
(43) Pub. Date: Oct. 18, 2007

(54) Tire detecting device

(75) Inventors: Wei-Chih Chien, Yongkang City (TW); Shiang-Wei Shiau, Jhunan Township (TW)

Correspondence Address: TROXELL LAW OFFICE PLLC, SUITE 1404, 5205 LEESBURG PIKE, FALLS CHURCH, VA, 22041, US

(73) Assignee: Legen Technology Company

(21) Appl. No.: 11/402,026

(22) Filed: Apr. 12, 2006

(51) Int. Cl. B60C 23/00

(52) U.S. Cl. 340/447

(57) ABSTRACT

The present invention provides a tire detector which is small, easily made and easily installed.

### FIELD OF THE INVENTION

The present invention relates to a detector; more particularly, relates to easily fabricating and installing a small detector for a tire.

### DESCRIPTION OF THE RELATED ART

A prior art, “An air-pressure alarm for a tire”, is proclaimed in Taiwan, which is installed at a blowing mouth of a tire to alarm at a low air pressure of the tire. The air-pressure alarm of the prior art comprises a metal shell, a valve, a diaphragm, a bushing, a tappet, an elastic member, a metal contact piece, a battery, a conductive member, a transmitting device, and a cover, where the metal shell has a horizontal seperating plate to obtain an upper room and a lower room; the seperating plate has a hole at center; the metal shell has an inward-convex shoulder near the top of the upper room; the valve is deposed in the lower room; the diaphragm is deposed on top surface of the seperating plate; the bushing is deposed in the upper room with a hole over the diaphragm; the tappet is deposed in the bushing and is butted against the diaphragm at bottom and is pierced at top through the hole of the bushing; a horizontally convex ring is formed near the bottom of the tappet; the elastic member is deposed between the convex ring of the tappet and the top of the bushing and is slipped on the surface of the tappet; the metal contact piece is deposed on top of the tappet and is straddled on the inward-convex shoulder the battery is deposed on top of the contact piece and is contacted with the contact piece at the negative pole; the conductive member is deposed on the positive pole of the battery; the transmitting device is deposed on top of the conductive member and the metal shell, and has a circuit board to connect to the conductive member and the metal shell respectively; the cover is covered at the outside on top of the metal shell; the metal contact piece is seperated from the inward-convex shoulder by the pushing-up of the metal contact piece when the tire has enough air pressure; and, the metal contact piece is contacted with the inward-convex shoulder by the lowering-down of the metal contact piece when the air-pressure of the tire is not enough.

The air-pressure alarm of the prior art can detect the air pressure of the tire and transfer the information to the driver by the transmitting device. However, because the air-pressure alarm is installed at the blowing mouth of the tire, every component of the alarm has to be small. In addition, the structure is complex which makes the assembling of the alarm become time-spending and difficult, not to mention with smaller components. Hence, the prior art does not fulfill users' requests on actual use.

### SUMMARY OF THE INVENTION

The main purpose of the present invention is to easily fabricate and install a small tire detecting device.

To achieve the above purpose, the present invention is a tire detecting device, comprising a detecting unit; a digital signal processor (DSP) unit having a power supplier; a signal output connecting to the DSP unit; and a receiver, where the detecting unit comprises a detector, an amplifier and an analog/digital (A/D) converter; the detector detects an air pressure in a tire; the A/D converter converts analog signals of air pressure into digital signals; the DSP unit connects to the detecting unit to receive the signals of air pressure to be transformed into signals required by the signal output; the signal output outputs signals received from the DSP unit; and, the receiver receives signals from the signal output. Accordingly, a novel tire detecting device is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a structural view showing a preferred embodiment according to the present invention;

FIG. 2 is a view showing a state of use according to the preferred embodiment of the present invention;

FIG. 3 is a view showing another state of use according to the preferred embodiment of the present invention;

FIG. 4 is a working-flow view showing a state of use of a detector according to the preferred embodiment of the present invention;

FIG. 5 is a view showing another state of use of the detector according to the preferred embodiment of the present invention; and

FIG. 6 is a view showing a state of use of a signal output according to the present invention.

### DESCRIPTION OF THE PREFERRED EMBODIMENT

The following description of the preferred embodiment is provided to understand the features and the structures of the present invention.

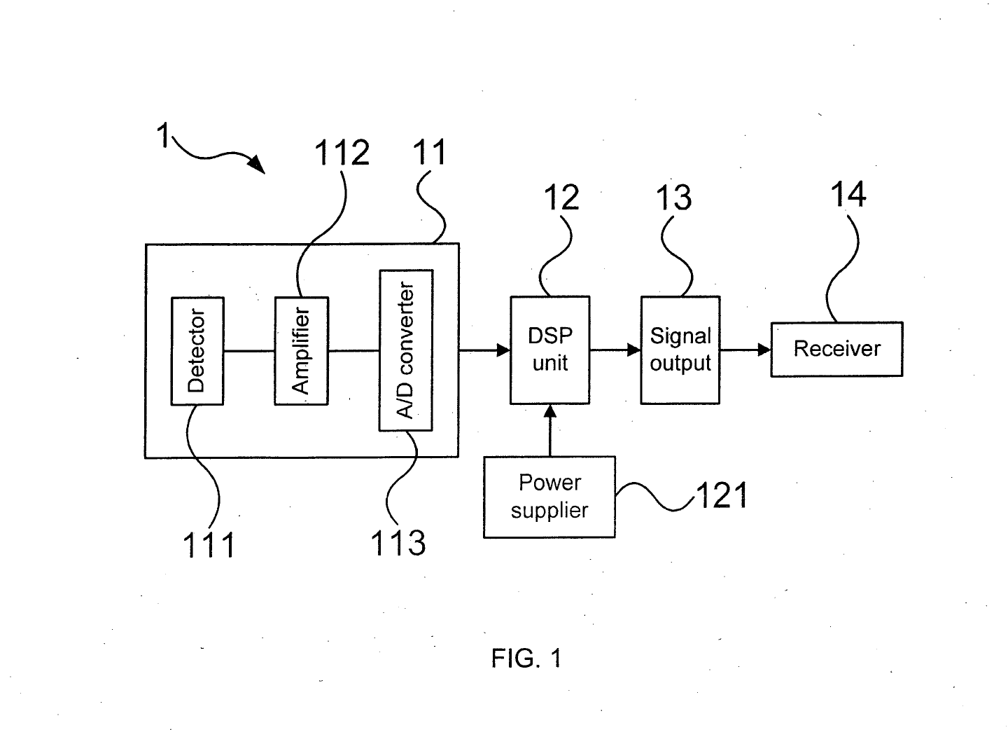

Please refer to FIG. 1, which is a structural view showing a preferred embodiment according to the present invention. As shown in the figure, the present invention is a tire detecting device 1, comprising a detecting unit 11, a digital signal processing (DSP) unit 12 a signal output 13 and a receiver 14, where the tire detecting device is small in size, is easy to be installed and is easy for fabricating.

The detecting unit 11 comprises a detector 111; an amplifier 112 connecting to the detector 111; and an analog/digital (A/D) converter 113 connecting to the amplifier 112.

The DSP unit 12 has a power supplier 121 which is a mercury battery, a Ni—Cd battery, a lithium ion battery or a rechargeable battery.

The signal output 13 is connected with the DSP unit 12, which can be a wire for transmitting signals, a bluetooth transmission module, a radio frequency (RF) transmission module or an infrared rays (IR) transmission module.

The receiver 14 receives signals from the signal output 13, which is a mobile phone, a Personal Digital Assistant (PDA), a central control system in a car, a signal-receivable key or a computer (a desktop or a laptop) capable of receiving Email. Thus, a novel tire detecting device is obtained.

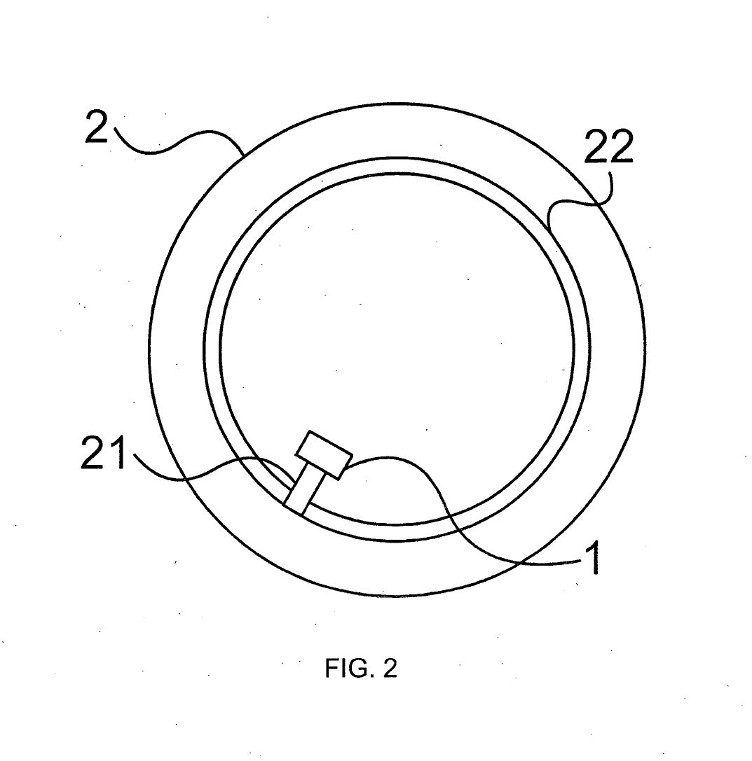

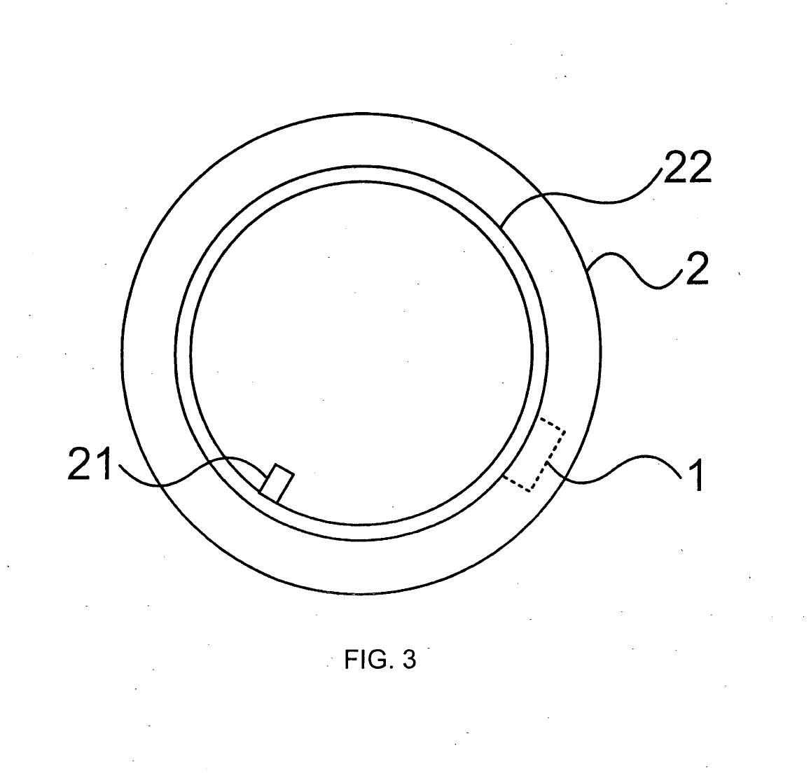

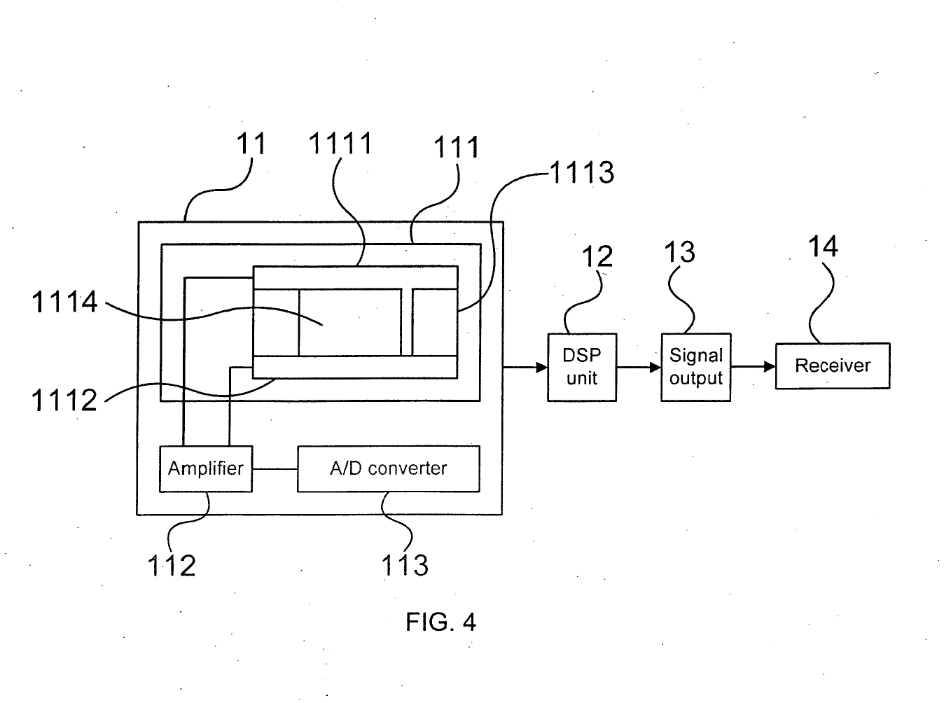

Please refer to FIG. 2 through FIG. 4, which are views showing a state of use and another state of use of the preferred embodiment; and a working-flow view showing a state of use of a detector of the preferred embodiment, according to the present invention. As shown in the figures, when using the present invention, a tire detecting device 1 according to the present invention is set at a blowing mouth 21 of a tire 2 (as shown in FIG. 2) or deposed in a fell y of the tire 2 (as shown in FIG. 3). When the signal output 13 is an infrared rays (IR) transmission module, the antenna used comprises a blowing mouth and a felly of the tire; and, the detector 111 of the detecting unit 12 comprises an electrode layer 1111; a piezoelectric transducer (PZT) layer 1112 corresponding to the electrode layer 1111; and an insulation part 1113 between the electrode layer 1111 and the PZT layer 1112, where a cavity part 1114 is formed between the electrode layer 1111 and the PZT layer 1112. When applying the tire detecting device 1 to a tire, an air pressure obtained from the air in the tire 2 and from that in the cavity part 1114 presses the PZT layer 1112 so that the PZT layer 1112 produces analog signals to the amplifier 112 corresponding to the electrode layer 1111. Then the A/D converter 113 convets the analog signals from the amplifier 112 into digital signals. The signals are further transferred to the DSP unit 12 to be transformed into required signals for the signal output 13. And the signal output 13 transfers the signals containing tire pressure information to be received by the receiver. By doing so, a user is able to know if the tire runs well under a proper pressure.

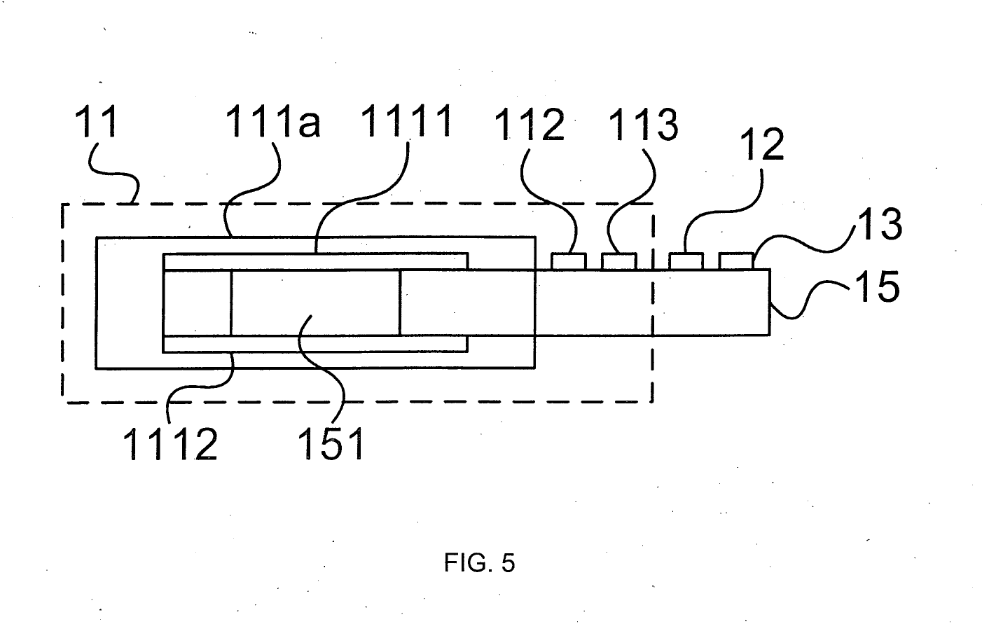

Please refer to FIG. 5, which is a view showing another state of use of the detector according to the preferred embodiment of the present invention. As shown in the figure, a detector 111a of a detecting unit 11 comprises a circuit board 15 having a hole 151, an electrode layer 1111, and a PZT layer 1112, where the electrode layer 1111 and the PZT layer 1112 are deposed at opposite sides of the hole respectively. An amplifier 112, an A/D converter 113, a DSP unit 12 and a signal output 13 are deposed at a side of the circuit board 15 which has a hole 151. The detector 111 a can be deposed at the blowing mouth 21 of the tire 2 (as shown in FIG. 2) or in a felly of the tire 2 (as shown in FIG. 3) so that a user is able to know if the tire runs well under a proper pressure.

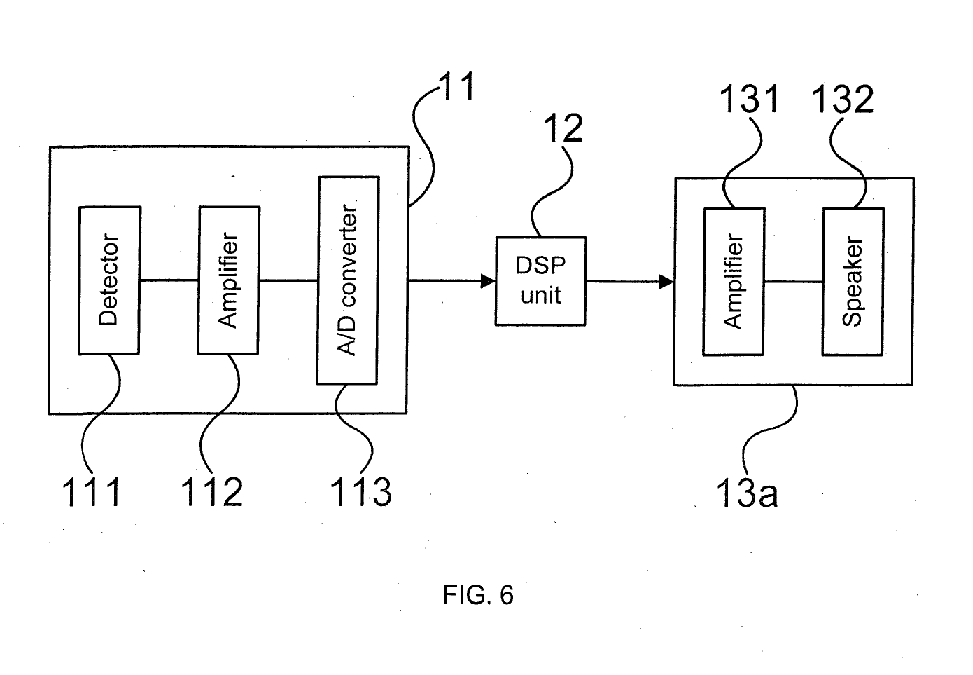

Please refer to FIG. 6, which is a view showing a state of use of a signal output according to the present invention. As shown in the figure, a signal output 13a according to the present invention comprises an amplifier 131 and a speaker 132 corresponding to the amplifier 131, where, when the signal output 13a receives a signal showing the abnormality of the tire, the signal is directly outputted with a sound by the speaker 132 to inform the user.

To sum up, the present invention is a tire detecting device, which comprises a detecting unit, a DSP, a signal output and a receiver to obtain a small size, an easy installation and an easy fabrication.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A tire detecting device, comprising
(a) a detecting unit, comprising a detector, an amplifier connecting to said detector, and an analog/digital (A/D) converter connecting to said amplifier;
b) a digital signal processing (DSP) unit, connecting to said detecting unit, said DSP unit having a power supplier;
(c) a signal output, connecting to said DSP unit; and
(d) a receiver, receiving signals from said signal output,
wherein said detector comprises an electrode layer; a piezoelectric transducer (PZT) layer, corresponding to said electrode layer; and an insulation part between said electrode layer and said PZT layer; and
wherein a cavity part is obtained between said electrode layer and said PZT layer.

2. The device according to claim 1
wherein said power supplier of said DSP unit is selected from a group consisting of a mercury battery, a Ni—Cd battery, a lithium ion battery and a rechargeable battery.

3. The device according to claim 1,
wherein said signal output is a wire to transmit signals.

4. The device according to claim 1
wherein said signal output comprises an amplifier, and a speaker connecting to said amplifier.

5. The device according to claim 1
wherein said signal output is a bluetooth transmission module.

6. The device according to claim 1
wherein said signal output is a radio frequency (RF) transmission module; and
wherein an antenna of said signal output comprises a blowing mouth and a felly of a tire.

7. The device according to claim 1,
wherein said said signal output is an infrared rays (IR) transmission module.

8. The device according to claim 1
wherein said receiver is selected from a group consisting of a mobile phone, a Personal Digital Assitant (PDA), a central control system in a car, a signal-receivable key, and a computer capable of receiving Email.

9. A tire detecting device, comprising
(a) a detecting unit, comprising a detector, an amplifier connecting to said detector, and an A/D converter connecting to said amplifier;
(b) a DSP, connecting to said detecting unit, said DSP unit having a power supplier;
(c) a signal output, connecting to said DSP unit; and
(d) a receiver, receiving signals from said signal output,
wherein said detector comprises
(a) a circuit board having a hole;
(b) an electrode layer; and
(c) a PZT layer; and
wherein said electrode layer and said PZT layer are respectively deposed at two sides of said hole.

10. The device according to claim 8,
wherein said power supplier of said DSP unit is selected from a group consisting of a mercury battery, a Ni—Cd battery, a lithium ion battery and a rechargeable battery.

11. The device according to claim 8,
wherein said signal output is a wire to transmit signals.

12. The device according to claim 8,
wherein said signal output comprises an amplifier, and a speaker connecting to said amplifier.

13. The device according to claim 8,
wherein said signal output is a bluetooth transmission module.

14. The device according to claim 8,
wherein said signal output is an RF transmission module; and
wherein an antenna of said signal output comprises a blowing mouth and a felly of a tire.

15. The device according to claim 8,
wherein said signal output is an IR transmission module.

16. The device according to claim 8,
wherein said receiver is selected from a group consisting of a mobile phone, a PDA, a central control system in a car, a signal-receivable key and a computer capable of receiving Email.
